(19) United States
(12) Patent Application Publication
(10) Pub. No.: US 2010/0295748 A1
(43) Pub. Date: Nov. 25, 2010

(54) Top End Cap Improvement

(75) Inventors: Eddie Ray Bradley, Richardson, TX (US); Troy Vanderhoof, Richardson, TX (US); Zoya Balter, Plano, TX (US)

Correspondence Address: HBS WELSH & KATZ - COMMSCOPE, INC., 120 S. RIVERSIDE PLAZA, 22ND FLOOR, CHICAGO, IL, 60606, US

(73) Assignee: ANDREW LLC, Hickory, NC (US)

(21) Appl. No.: 12/468,159

(22) Filed: May 19, 2009

(51) Int. Cl. H01Q 1/42; H01P 11/00

(52) U.S. Cl. 343/872; 29/600

(57) ABSTRACT

A housing for an antenna has an end member having a radome seat and a back extension. The end member also has at least one actuator housing with an external opening and an internal opening. The end member has no through passage from its external side to its internal side, other than the opening of the actuator housing, such that upon assembly with a back and a radome, the antenna is water-tight. A retention assembly has an internal retaining member and an internal retaining member receiver. An actuator has an external actuation interface, and is mounted in the actuator housing to be water-tight. The retention assembly has a first position and a second position. The first position engages the internal retaining member with the internal retention receiver such as to maintain a closed water-tight engagement with the back and the radome. The retention assembly has a second, released position, that allows disengagement of the end member from a reflector tray.

### CROSS-REFERENCE TO RELATED APPLICATIONS

None.

### BACKGROUND OF THE INVENTION

1. Field of the Invention

The present invention is in the field of antennas used for cellular telephone services and the like, and in particular assembly and housing apparatuses and methods therefore.

2. Related Art

Cellular telephone antennas typically mount a plurality of operative components on a generally flat, rectangular, vertically elongated plate sometimes called a reflector tray. These components must be securely mounted on towers and protected from the weather once mounted. Antennas are mounted on cellular towers in an elevated position which subjects them to wind load. Accordingly, the housing components and the fixation of the operative components on their reflector tray must be sturdy and water-tight.

Housings for such antennas include a back, outward facing radome, a top and a bottom. The current techniques for assembling these housings use a disadvantageous plurality of parts, plates, fixators, through holes, and are complex, expensive and cumbersome in assembly and use.

### SUMMARY OF THE INVENTION

A housing for an antenna has an end member having a radome seat and a back extension. The end member also has at least one actuator housing with an external opening and an internal opening. The end member has no through passage from its external side to its internal side, other than the opening of said actuator housing, such that upon assembly with a back and a radome, the antenna is water-tight. A retention assembly has an internal retaining member and an internal retaining member receiver. An actuator has an external actuation interface, and is mounted in the actuator housing to be water-tight. The retention assembly has a first position and a second position. The first position engages the internal retaining member with the internal retention receiver such as to maintain a closed water-tight engagement with the back and the radome. The retention assembly has a second, released position, that allows disengagement of the end member from a reflector tray.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a rear perspective view of an antenna,

FIG. 2 is a perspective cutaway view of the invention in the first position,

FIG. 3 is a perspective cutaway view of the invention in a second position,

FIG. 4 is an end cutaway view of the invention in a first position,

FIG. 5 is an end cutaway view of the invention in a second position,

FIG. 6 is a perspective view of an end member,

FIG. 7 is a perspective view of a receiver,

FIG. 8 is a perspective view of an actuator,

FIG. 9 is a cutaway close-up of an actuator housing.

### DETAILED DESCRIPTION OF THE PREFERRED EMBODIMENTS

The following description of the preferred embodiment(s) is merely exemplary in nature and is in no way intended to limit the invention, its application, or uses.

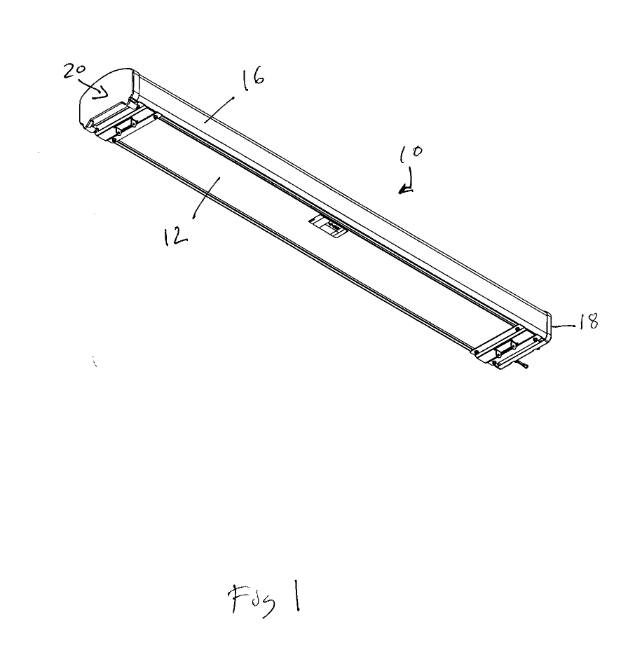

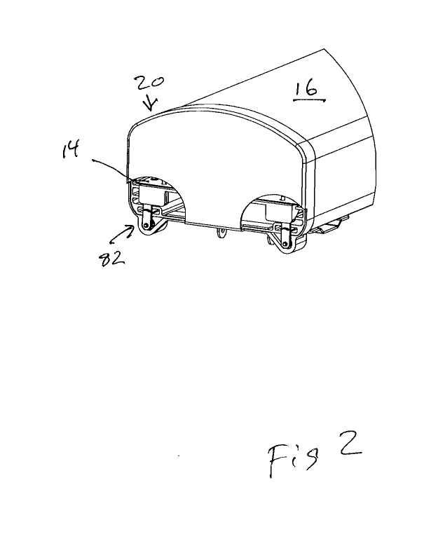

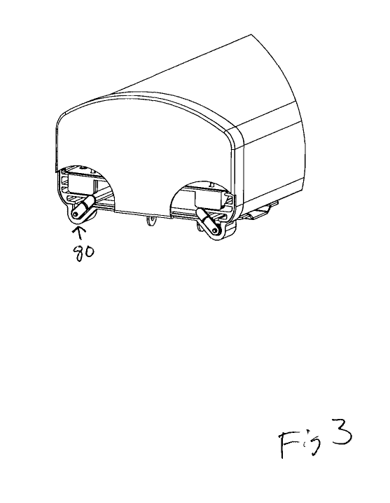

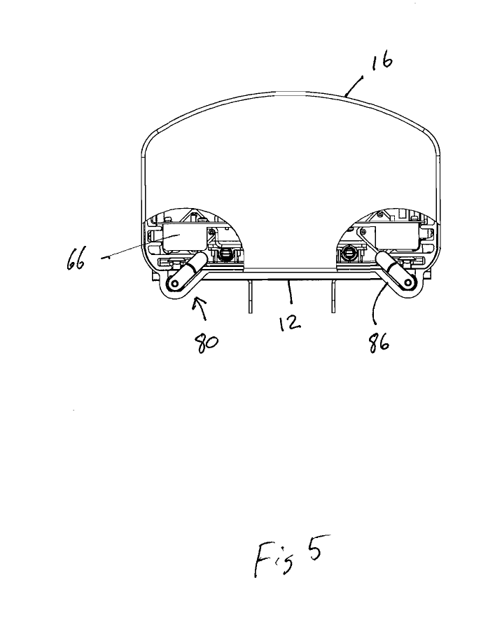

FIG. 1 is a rear perspective view of a cellular telephone antenna 10. The antenna 10 is comprised of a back 12 which is generally planar and generally rectangular. The back 12 is assembled with a radome 16, which in the depicted embodiment is curvilinear on an outward face and dimensioned to mate with the rectilinear periphery of the back 12. Upon assembly, the back 12 and radome 16 encapsulate between them a reflector tray 14 (see cutaway views in FIGS. 2 through 5). Upon the reflector tray 14 are mounted a multiplicity of operative components generally configured to transmit radio frequency signals carrying data transmissions such as cellular telephone calls. The back 12 generally serves as a base upon which any of a variety of brackets, plates, holes, seats and other apparatuses may be formed or attached in order to mount the antenna 10 in its installed position on a cellular telephone tower. The reflector tray 14 may be a separate, generally planar component fixedly attached to the overall antenna 10, or it may be an inner surface of back 12. Housing of the operative antenna components is completed by the assembly of back 12 and radome 16 with a bottom end member 18 and a top end member 20.

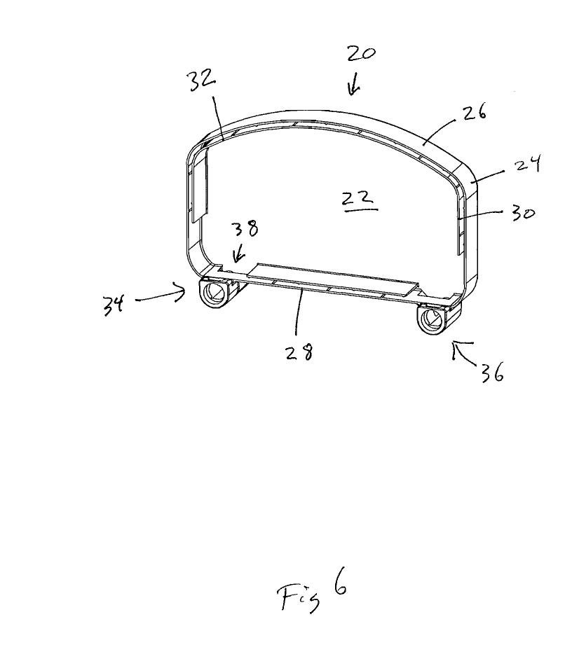

FIG. 6 shows a perspective view of an isolated end member 20. The end member 20 is comprised of an end surface 22 and a substantially orthogonal rim 24. In the depicted embodiment, the rim 24 includes a curvilinear outward facing portion 26 and a substantially straight rear portion 28. The rear portion 28 forms an extension dimensioned to mate with the back 12 of the antenna 10 such that an inner face of extension 28 is flush with an outer surface of back 12 and in water tight contact with it after assembly. The end member 20 also includes an inner lip 30, which also extends orthogonally to the back surface 22. The outer rim 26 forms an outer lip which, in concert with the inner lip 30 are dimension to define seat for receiving an end edge of the radome 16. Upon assembly, the radome may be sealed in the seat 32 provided for it, as for example with epoxy putty.

The end member 20 also includes at least one actuator housing 34. In the depicted embodiment, there are 2 actuator housings. The actuator housing 34 includes an external opening 36 and an internal opening 38. In the depicted embodiment there are no other openings in the end member 20 from the outside into an internal space of the final assembled antenna 10. Accordingly, the end-cap and radome assembly is water-tight. “Water-tight” as used herein, means that a normal antenna assembled according to the present invention may last a normal service lifetime without damage to or interference with its interior components from normal exposure to moisture, such as wind and rain. In the depicted embodiment, the end member is made of a plastic material. In one embodiment, one of a variety of polymers that may be used includes ryton-R4. The end members, backs, and radomes may be fiberglass reinforced plastic.

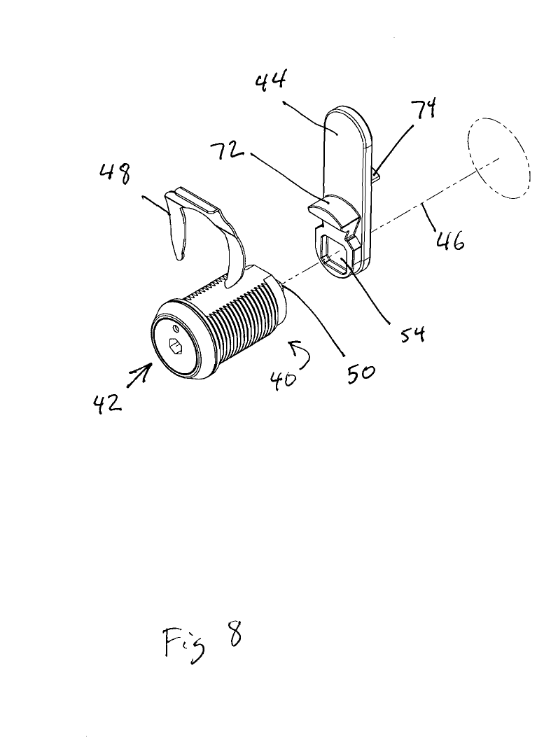

FIG. 8 depicts an actuator 40. Its aspects include an external actuation interface 42. The actuator 40 is assembled to be fixedly attached to an internal retention member 44. In the depicted embodiment, actuator 40 is a latch, the external actuation interface 42 is an alien receptacle and the internal retention member 44 is a pawl. The actuator 40 includes an axis 46 in which a cam may be turned by turning the allen receptacle 42.

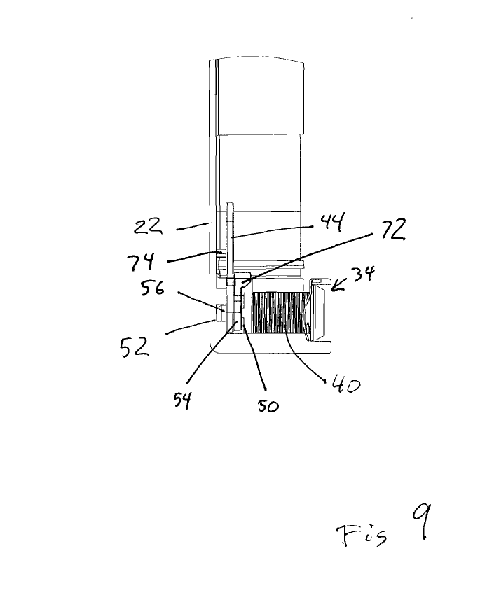

In assembly, the internal retention member 44 is placed in internal opening 38, such that a cam seat 54 in the first end of a retention member is aligned with a substantially centered axis of the external opening 36 and the axis cam 46 of the actuator 40. The actuator 40 is then placed in the actuator housing 34 by inserting it in external opening 36. The actuator cam 50 proceeds into the cam seat 54 provided for it in the first end of internal retention member 44. In the depicted embodiment, an integral pivot pin 56 is located on an opposite side of the internal retention member 44 from the cam seat 54 and is substantially aligned with the axis of rotation 46. Pivot pin 56 thereafter seats in a recess 52 provided for it in the end surface 22 of end member 20. (See FIG. 9). The actuator 40 may be retained in this position as in the depicted embodiment, which includes a snap-ring 48. A first spacing extension 72 and an opposing second extension 74 are dimensioned to properly align retaining member 44 with slot 70 defined in the internal retention member receiver 60 and to maintain proper alignment in use. The dimensions of the elements are such that an assembler may hold the internal retaining member 44 in the recess 86 provided and insertion of the cam into the cam seat will automatically properly align the elements in a “blind” fashion.

In the depicted embodiment, a second actuator and internal retention member may be assembled in a second actuator housing in the same manner used for the first actuator.

The water-tight aspect of the end member 20 is further improved by the orientation of the actuator housing 34, whose opening is downward in the final installed position, thereby avoiding direct exposure to rain and avoiding puddling.

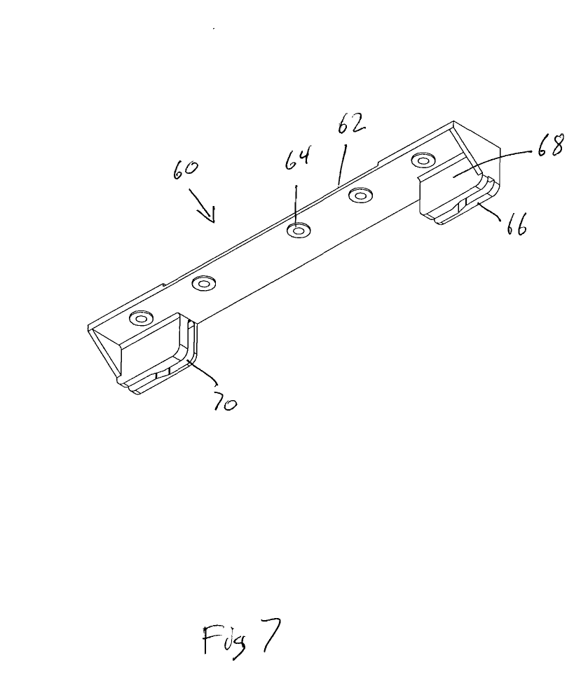

FIG. 7 depicts an internal retention receiver 60. The internal retention receiver includes a mating surface 62 and a fixation member 64 for attaching to the reflector tray 14. The internal retention receiver is disposed such that, upon assembly, top extension 66 and bottom extension 68 cooperate to define therebetween a retention receiving slot 70. Together the actuator housing 34, internal retention member 44 and internal retention receiver 60 comprise a retention assembly.

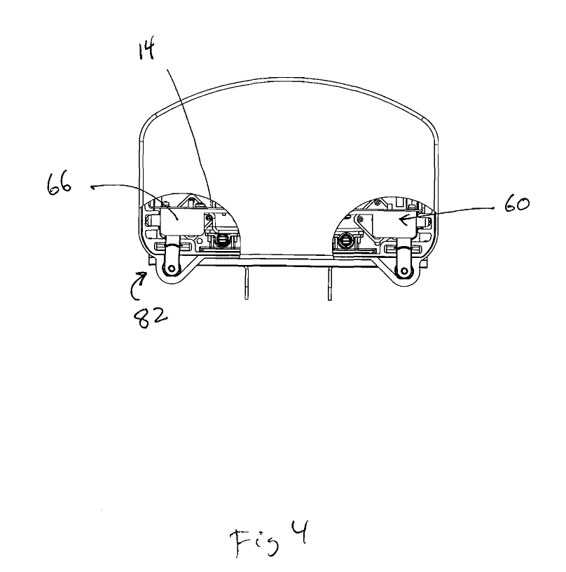

As is best seen in FIGS. 2 through 5, the retention assembly, and in particular the internal retention member 44, have a first and a second position. The first position is a release position 80 wherein the internal retention member 44 is disengaged from the internal retention receiver 60. The internal opening 38 of the actuator housing 34 in the end member 20 includes a space 86 dimensioned to receive the internal retaining member 44 in the first, disengaged position. In the engaged position shown in FIGS. 2 and 4, the internal retention member 44 extends into slot 70 in between extensions 66 and 68. The external dimensions of the internal receiving member 44 and the internal dimensions of the slot 70 are dimensioned to closely cooperate in order to achieve a snug fit.

In assembly a radome 16 is seated in the end member 20 by insertion between mating lips 26 and 30 and, optionally, may be sealed there. Separately, operative components will have been mounted on reflector tray 14 and assembled with a back 12. Optionally, the reflector tray/back assembly may be fixedly attached to a bottom member 18. The radome top end member assembly may then be placed or slid over and onto the reflector tray and/or back assembly and advanced to its final position, fully encapsulating the reflector tray and operative components. The bottom of radome 16 engages the bottom end, and the top of back 12 engages extension 28 of end member 20. The interior retention members 44 will be in the first, disengaged position, and rotated to be flush with the disengagement seats 86. Thereafter, the external actuation interface, the allen receptacle 42 depicted in the embodiment, is turned such that the internal engagement member, the pawl 44 depicted in the embodiment, rotates into the slot 70, where, in close cooperation therewith, a retaining configuration is achieved and maintained. Similarly, the radome 16 and end member 20 assembly may be disengaged and removed from the reflector tray and other components with advantageous simplicity. In the depicted embodiment, only two disengagement or release actions are necessary for this disassembly; rotating the first actuator to the first, disengaged position 80 and then likewise disengaging the second retention assembly. Then the internal components may be exposed by sliding the radome/end assembly off. This advantage is consequential for manufacturing through-put. Substantially all antennas must be tuned at the factory in order to ensure that the operating components are set to the proper operating frequency and that the signal strength and accuracy meet quality standards. This testing is done with hard-wired test apparatus connections that attach inside the antennas to the components on the reflector tray inside the assembled antenna. The test must be executed with the antenna assembled. Accordingly, a back/reflector tray/radome/end cap assembly that is complex and uses plurality of bolts, mounting plates and the like, is disadvantageously time consuming. A disassembly procedure having only 2 steps such as that embodied by the present invention is therefore advantageous. Reassembly is executed in a “blind” manner. That is to say, the worker's engagement and use of the external actuation interface operates the retention assembly and completes the housing assembly for shipping and installation without the need for opening the assembly for access to internal fixation components.

In the depicted embodiment, the internal retention receiver 60, internal retention member 44, and the end member 20 are all made out of polymers. The use of polymers for any one or all of these elements advantageously minimizes the number and surface area of metal to metal contact of components. Metal to metal component contact, particularly of dissimilar metals, is a source of intermodulation distortion. Intermodulation distortion can lead to unacceptably low quality signal outputs by the antenna as a whole, both initially and over time, as corrosion, wear and assembly relaxation caused by wind loading and the like exacerbate intermodulation distortion. Accordingly, because the component configuration of the present invention minimizes the surface areas necessary to achieve appropriately secure housing of the antenna, intermodulation distortion is advantageously minimized. Moreover, the choice of polymer components further advantageously minimizes distortion.

As various modifications could be made to the exemplary embodiments, as described above with reference to the corresponding illustrations, without departing from the scope of the invention, it is intended that all matter contained in the foregoing description and show in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An end member for an antenna comprising:
an end member, said end member having a radome seat and a back extension;
said end member also having at least one actuator housing, said actuator housing having an external opening and an internal opening;
said end member being without through passage from its external side to its internal side, other than said at least one opening of said actuator housing, such that upon assembly with a back and a radome, said antenna is water-tight;
a retention assembly, said retention assembly comprising;
an internal retaining member
an internal retaining member receiver;
an actuator, said actuator having an external actuation interface, said actuator being mounted in said actuator housing and said actuator mounting being water-tight;
said retention assembly having a first position and a second position, said first position engaging said internal retaining member with said internal retention receiver such as to maintain a closed, water-tight engagement with said back and said radome;
said retention assembly having a second, released position, said released position allowing disengagement of said end member from said internal retaining member receiver; and
said external actuation interface mediating movement of said retention assembly between said first position and said second position.

2. The apparatus of claim 1 wherein said release of said end member from said internal retaining member receiver is executable in no more than two (2) release actions.

3. The apparatus of claim 1 wherein said internal retention member is non-metallic.

4. The apparatus of claim 1 wherein said internal retention member receiver is non-metallic.

5. The apparatus of claim 1 wherein said movement between said first position and second position is blind.

6. The apparatus of claim 1 further comprising;
said internal retaining member being a pawl;
said internal retaining member receiver being a slot; and
said pawl being dimensioned to retainingly engage said slot in close cooperation when said retention assembly is in said first position.

7. The apparatus in claim 1 wherein said end member includes a seat dimensioned to receive a radome edge in assembly.

8. The apparatus of claim 1 wherein said end member is assembled with a radome.

9. The apparatus of claim 1 wherein said actuator is a latch.

10. The apparatus of claim 1 wherein said external opening of said end member is oriented to face downward in a final mounted position of the antenna.

11. A method of assembling a cellular telephone antenna comprising:
providing a first end member and a second end member, a radome and an assembly of a back and a reflector tray;
fixedly attaching said radome to one of said first or said second end members:
attaching said assembly of said back and said reflector tray to the other of said first or second end members;
installing in a housing provided for it in one said first or said second end members a retention assembly, said retention assembly having an internal retention member;
disposing on one of said radome or said assembly of said back and said reflector tray a internal retention member receiver, said internal retention member receiver being positioned to retainingly receive said internal extension member upon final assembly;
sliding said attachment of said radome and one of said first or second end members into a closely cooperating final assembly with said assembly of said back and said reflector tray together with said second end member; and
engaging said internal retention member with said internal retention member receiver with two or fewer engagement actions, such that said final assembly is water-tight.

12. The method of claim 11 further comprising;
attaching of a lead for test equipment to at least one operative component on said reflector tray before said final assembly such that testing of the antenna may be completed;
disassembling said antenna with two or fewer release actions;
removing said test equipment leads; and
reestablishing final assembly of said antenna with two or fewer engagement actions.

13. The method of claim 11 wherein said release of said end member from said internal retaining member receiver is executable in no more than two (2) release actions.

14. The method of claim 11 wherein said internal retention member is non-metallic.

15. The method of claim 11 wherein said internal retention member receiver is non-metallic.

16. The method of claim 11 wherein said movement between said first position and second position is blind.

17. The method of claim 11 further comprising;
said internal retaining member being a pawl;
said internal retaining member receiver being a slot; and
said pawl being dimensioned to retainingly engage said slot in close cooperation when said retention assembly is in said first position.

18. The method in claim 11 wherein said end member includes a seat dimensioned to receive a radome edge in assembly.

19. The method of claim 11 wherein said end member is assembled with a radome.

20. The method of claim 11 wherein said actuator is a latch.

21. The method of claim 11 further comprising orienting said external opening of said end member to face downward in a final mounted position of the antenna.
